(19) United States
(12) Patent Application Publication
(10) Pub. No.: US 2021/0170783 A1
(43) Pub. Date: Jun. 10, 2021

(54) METHOD FOR SEPARATING AND CATEGORIZING AT LEAST ONE SUBSTRATE, AND SUBSTRATE CATEGORIZING MACHINE

(71) Applicant: KOENIG & BAUER AG, Würzburg (DE)

(72) Inventors: Thomas HENDLE, Morrens (CH); Thomas TÜRKE, Lonay (CH)

(21) Appl. No.: 17/271,521

(22) PCT Filed: Aug. 22, 2019
(86) PCT No.: PCT/EP2019/072463

§ 371 Date: Feb. 25, 2021

(30) Foreign Application Priority Data
Sep. 26, 2018 (DE) 10 2018 123 773.1

(51) Int. Cl. B42D 25/48; B07C 5/36; B65H 31/24; B65H 29/62; B65H 43/04

(52) U.S. Cl. CPC B42D 25/48; B07C 5/361; B41M 3/14; B65H 29/62; B65H 43/04; B65H 31/24

(57) ABSTRACT

The invention relates to a method for separating and categorizing at least one substrate (02; 03) that originates from a sheet source (47) or is transported in the form of a material web (02) to a cross-cutting apparatus and is separated into a multiplicity of sheets (03) there, wherein the respective sheets (03) are inspected in respective inspection operations with regard to at least one property that the substrate (02; 03) already had before the particular separating operation or severing operation, and wherein the sheets (03) are each assigned to one of at least three categories in an assigning operation on the basis of the result of the inspection carried out in the particular inspection operation, and wherein each of the sheets (03) is deposited on a delivery pile (06; 07; 08) corresponding to its category, and to a substrate categorizing machine (01), which has a sheet source (47) or a material-web source (09) and a cross-cutting device (11), wherein the substrate categorizing machine (01) has, downstream of the sheet source (47) or downstream of the cross-cutting device (11), a sheet transport device (12) having a gripper system (13), and an inspection device (14; 16; 17; 18), and, downstream of the inspection device (14; 16; 17; 18), a delivery apparatus (19), which has at least three depositing stations (21; 22; 23).

The invention relates to a method for separating and categorising at least one substrate and a substrate categorising machine.

For the production of security papers, for example banknotes, special substrates are usually used, for example paper substrates, polymer substrates or hybrid substrates which have a mixture of paper and polymer. Substrates made of paper for the production of security papers, in particular banknotes, are usually produced from cotton fibres and thus differ from other sorts of paper which are instead produced from lignin and/or cellulose. In order to produce security paper or banknote paper, cotton fibres are usually mixed with water, with it being possible for example to also add linen or other plant fibres thereto. Dyes are optionally added thereto. The mixture is then filtered through a corresponding mould, as a result of which watermarks can be produced. The substrate may also be provided with other security features aside from watermarks. For example, security threads are incorporated into the substrate. Alternatively or additionally, other security features are arranged on at least one side of the substrate, for example printed images and/or foil material, which is for example applied by hot-foil embossing. Further information regarding paper production can be found for example in EP 0 059 056 A1, EP 0 229 645 A1, EP 1 630 285 A2, GB 2 397 582 A and GB 2 433 470 A.

Polymer substrates are usually produced from a transparent film which consists for example of biaxially oriented polypropylene (BOPP) and is provided with an opaque layer on one or both sides, for example by an intaglio printing method. In order to produce another type of security feature, particularly common in polymer substrates, this opaque layer is omitted in some regions, such that transparent regions are left behind. Like paper substrates, polymer substrates can also be provided with a plurality of further security features even as they are being produced, for example security features with optically variable surfaces, such as holograms, kinegrams, iridescent regions, etc.

These transparent foils are for example produced in a process by a bubble or tube first being produced, and a highly transparent and stable foil being produced therefrom, which foil is in the form of a continuous transparent material web. This is then guided through a series of printing mechanisms and other processing mechanisms, where the opaque layer and/or other security features are applied. Production of such a foil is described for example in WO 83/00659 A1.

In order to produce hybrid substrates, layers made of paper and of polymer are joined together, in order to combine the advantages of both materials. A method for producing hybrid substrates is described in EP 2153 988 A1. For example, a paper layer and a polymer layer can be joined together. Alternatively, at least one paper layer can be arranged between at least two polymer layers and joined thereto. Alternatively, at least one polymer layer can be arranged between at least two paper layers and joined thereto.

The substrates described are usually produced in the form of material webs. These material webs are then usually wound up to give rolls, or cut into sheets and thus transported to corresponding processing facilities, in particular security printing works.

If the substrate in question is faulty, this usually leads to security papers produced therewith, in particular banknotes, being unusable.

EP 0 286 317 A1 discloses a method and a substrate processing machine, wherein a material web is inspected, numbered, inspected again and then cut, and the sheets are supplied to different categories. The sheets have a gap and are then only cross-cut and packaged.

EP 1 932 678 A1 discloses a method in which sheets are processed and then assigned to different categories.

EP 3 421 663 A1 describes a method and a device wherein substrate in the form of a material web is inspected and then cut into sheets, and the resulting sheets are split into three different delivery piles on the basis of the inspection.

WO 03/052394 A1 and WO 2012/059861 A1 disclose inspection devices.

The object of the invention is to create a method for separating and categorising at least one substrate and a substrate categorising machine.

The object is achieved according to the invention by the features of claim 1 and the features of claim 2 and the features of claim 16 and the features of claim 17.

Preference is given to a method for categorising at least one substrate, wherein sheets are each assigned to one of at least three categories in a respective assigning operation on the basis of a result of an inspection carried out in a respective inspection operation, and wherein each of the sheets is deposited on a delivery pile corresponding to its category in a respective delivery operation. The sheets are for example severed from a roll of material or originate from another sheet source, for example a sheet feeder.

In an alternative or additional further development, the method is preferably characterised in that the method is a method for separating and categorising at least one substrate, wherein substrate is transported in the form of a material web along a provided transport path to a cross-cutting device in a web supplying operation and wherein the material web is separated into a plurality of sheets by respective sheets being severed from the material web in a respective severing operation and wherein the respective sheets are inspected in at least one respective inspection operation in each case with regard to at least one property that the substrate already had before the respective severing operation. Preference is accordingly given to a method for separating and categorising at least one substrate, in particular security paper substrate, wherein substrate is unwound in the form of a material web from a roll of material preferably in an unwinding operation and wherein substrate is transported in the form of a material web along a provided transport path to a cross-cutting device in a web supplying operation and wherein the material web is separated into a plurality of sheets by respective sheets being severed from the material web in a respective severing operation and wherein the respective sheets are inspected in at least one respective inspection operation in each case with regard to at least one property that the substrate already had before the respective severing operation, and wherein the sheets are each assigned to one of at least three categories in a respective assigning operation on the basis of the result of the inspection carried out in the respective at least one inspection operation, and wherein each of the sheets is deposited on a delivery pile corresponding to its category in a respective delivery operation. This at least one property is preferably selected from substrate faults such as inclusions of foreign bodies and/or holes; watermarks, in particular the position and/or completeness thereof; security threads, in particular the position and/or completeness and/or width and/or possible rotations thereof; reflective window threads, for example with holographic properties, in particular the position and/or completeness and/or rotation and/or width thereof and/or a number and/or length and/or width of apertures in the window thread; applied foils, in particular the position and/or completeness thereof; printed images, in particular the colouring and/or print registration accuracy and/or registration accuracy and/or completeness thereof.

In an alternative or additional further development, the method is preferably characterised in that substrate is removed in the form of a respective sheet from a feed pile and is isolated in a respective isolation operation, and in that the respective sheet is transported in particular by means of at least one gripper system along a provided transport path to at least one inspection device in a respective sheet supplying operation, and in that the respective sheets are inspected in at least one respective inspection operation in each case with regard to at least one property that this respective sheet already had before the respective isolation operation. Accordingly, preference is given to a method for categorising at least one substrate, wherein substrate is removed in the form of a respective sheet from a feed pile and is isolated in a respective isolation operation, and wherein the respective sheet is transported in particular by means of at least one gripper system along a provided transport path to at least one inspection device in a respective sheet supplying operation, and wherein the respective sheets are inspected in at least one respective inspection operation in each case with regard to at least one property that this respective sheet already had before the respective isolation operation, and wherein the sheets are each assigned to one of at least three categories in a respective assigning operation on the basis of the result of the inspection carried out in the respective at least one inspection operation, and wherein each of the sheets is deposited on a delivery pile corresponding to its category in a respective delivery operation. In an alternative or additional further development, the method is preferably characterised in that the sheets are exclusively transported along the transport path from the feed pile to the at least one inspection device and in particular no material is applied to the sheets or removed from the sheets and the sheets and/or the substrate thereof are in particular not irreversibly changed.

The advantages which can be achieved with the invention consist in particular of printing works being able to use substrate in a targeted manner based on its quality. As a result, on the one hand the risk can be reduced or done away with that valuable substrate is used for set-up processes or the like, and on the other hand the risk can be reduced or done away with that unusable substrate is further processed in expensive processing operations, despite it being clear from the outset that no acceptable printed products, in particular security papers and/or banknotes, could be produced in this way. A further advantage consists in being able to optimise the provision of substrate sheets and in operators receiving clear indications regarding to which category sheets in front of them belong, and what they should be used for.

In an alternative or additional further development, the method is preferably characterised in that the material web is subjected to at least one processing operation at a processing point arranged along the transport path provided for the transport of substrate before a cross-cutting device which carries out the respective severing operation, and further preferably in that the respective processing operation is applying a security feature and/or embossing and/or applying a foil and/or printing and/or the offset printing operation and/or an intaglio printing operation and/or a screen printing operation and/or a hot stamping operation and/or a coating operation and/or a flexographic printing operation and/or a relief printing operation and/or a letterpress printing operation and/or a numbering operation and/or a varnishing operation and/or an inkjet printing operation and/or an operation for applying microlenses.

In an alternative or additional further development, the method is preferably characterised in that the respective sheets are subjected to at least one processing operation after the respective severing operation and before the respective at least one inspection operation and further preferably in that the processing operation is applying a security feature and/or embossing and/or applying a foil and/or printing and/or the offset printing operation and/or an intaglio printing operation and/or a screen printing operation and/or a hot stamping operation and/or a coating operation and/or a flexographic printing operation and/or a relief printing operation and/or a letterpress printing operation and/or a numbering operation and/or a varnishing operation and/or an inkjet printing operation and/or an operation for applying microlenses.

In an alternative or additional further development, the method is preferably characterised in that one category of the at least three categories is an approved sheet category, to which those sheets which completely meet the stipulated quality requirements are assigned, and/or in that one category of the at least three categories is a reject category, to which those sheets which are completely unusable, at least for the production of security papers, in particular banknotes, are assigned, and/or in that one category of the at least three categories is a mixed category, to which those sheets which do not completely meet the stipulated quality requirements, but only have small flaws and are at least partially usable, are assigned.

In an alternative or additional further development, the method is preferably characterised in that the substrate is unwound in the form of a material web from a roll of material in an unwinding operation. In an alternative or additional further development, the method is preferably characterised in that all said method operations are carried out in the same substrate processing machine.

In an alternative or additional further development, the method is preferably characterised in that, in the respective at least one inspection operation, the respective sheet is subjected to a one-sided reflection inspection and/or is subjected to a two-sided reflection inspection and/or is subjected to a transmission inspection and/or is subjected to a separation point inspection and/or to a length inspection. As a result, the sheets can be investigated for as broad a range of faults as possible. During their respective inspection operation, the respective sheets are preferably arranged held by at least one gripper system. By inspecting the sheets, in particular in conjunction with a gripper system, a particularly accurate inspection is possible, in particular because of the relative position between sheet and inspection device which is as exact as possible.

In an alternative or additional further development, the method is preferably characterised in that at least the respective sheets which were assigned to a first of the at least three categories are subjected to at least one processing operation after the respective assigning operation and further preferably in that the processing operation is applying a security feature and/or embossing and/or applying a foil and/or printing and/or the offset printing operation and/or an intaglio printing operation and/or a screen printing operation and/or a hot stamping operation and/or a coating operation and/or a flexographic printing operation and/or a relief printing operation and/or a letterpress printing operation and/or a numbering operation and/or a varnishing operation and/or an inkjet printing operation and/or an operation for applying microlenses.

Preference is furthermore given to a substrate categorising machine. The substrate categorising machine serves in particular to sort sheets into different categories depending on their nature. The substrate categorising machine is designed for example as a substrate processing machine, in particular if substrate is supplied in the form of a material web and/or roll of material. Alternatively to supplying the substrate in the form of a material web and/or roll of material, the substrate is supplied in the form of sheets, in particular in the form of a feed pile.

In an alternative or additional further development, the substrate categorising machine is preferably characterised in that the substrate categorising machine is designed as a substrate processing machine, in particular as a security paper processing machine. In an alternative or additional further development, the substrate categorising machine is preferably characterised in that the substrate categorising machine has at least one material web source and/or at least one web transport system. The at least one material web source is preferably designed as a roll unwinding device or alternatively for example as a substrate producing device and/or papermaking device and/or polymer producing device and/or hybrid substrate producing device. The web transport system preferably serves to transport a material web, in particular regardless of whether same is unwound from a roll or originates directly from a production or arrives at the substrate feed device by some other means. The substrate categorising machine, in particular substrate processing machine, has at least one cross-cutting device, in particular cross-cutting guillotine device, along a transport path provided for the transport of at least one substrate after the material web source and/or after the web transport system, wherein the substrate categorising machine has at least one sheet transport device along the transport path provided for the transport of the substrate after the at least one cross-cutting device, which sheet transport device has at least one gripper system.

In an alternative or additional further development, the substrate categorising machine is preferably characterised in that the substrate categorising machine has at least one sheet source, in particular designed as a sheet feeder, and further preferably in that the substrate categorising machine has at least one sheet transport device along a transport path provided for the transport of sheet-like substrate after the sheet source, which sheet transport device has at least one gripper system.

In an alternative or additional further development, the substrate categorising machine is preferably characterised in that the substrate categorising machine has at least one inspection device. Depending on the design of the substrate categorising machine, this at least one inspection device is preferably arranged along the transport path provided for the transport of the substrate after the at least one cross-cutting device and/or along the transport path provided for the transport of the sheet-like substrate after the sheet source. Alternatively to the sheet feeder, the material web source, the web transport system and the at least one cross-cutting device can for example be considered together as the sheet source.

In an alternative or additional further development, the substrate categorising machine is preferably characterised in that the substrate categorising machine has at least one delivery device along the transport path provided for the transport of the substrate after the at least one inspection device, which delivery device has at least three depositing stations arranged in particular one behind the other along the transport path provided for the transport of substrate.

In an alternative or additional further development, the substrate categorising machine is preferably characterised in that only sheet transport devices which act on and/or are capable of acting on the sheet-like substrate are arranged along the transport path provided for the transport of the sheet-like substrate between the sheet source and the at least one inspection device and/or in that no devices for applying material to the sheet-Ike substrate and/or for removing material from the sheet-like substrate and/or for irreversibly changing the sheet-like substrate are arranged to act on and/or be capable of acting on the sheet-like substrate along the transport path provided for the transport of the sheet-like substrate between the sheet source and the at least one inspection device.

In an alternative or additional further development, the substrate categorising machine is preferably characterised in that the substrate categorising machine has at least one web processing device for processing the material web and/or in that the substrate categorising machine has at least one web processing device for processing the material web which is designed as a foil application device and/or as a hot stamping device and/or as an embossing device and/or as a coating device and/or as a printing device and/or as an offset printing device and/or as a flexographic printing device and/or as a screen printing device and/or as an intaglio printing device and/or as a relief printing device and/or as a letterpress printing device and/or as a numbering device and/or as a varnishing device.

In an alternative or additional further development, the substrate categorising machine is preferably characterised in that the substrate categorising machine has at least one sheet processing device for processing the sheets, which sheet processing device is arranged along the transport path provided for the transport of substrate after the at least one cross-cutting device and before the at least one inspection device and/or in that the substrate categorising machine has at least one sheet processing device for processing the sheets, which sheet processing device is arranged along the transport path provided for the transport of substrate after the at least one inspection device and before the at least one delivery device.

In an alternative or additional further development, the substrate categorising machine is preferably characterised in that the at least one sheet processing device is designed as a foil application device and/or as a hot stamping device and/or as an embossing device and/or as a coating device and/or as a printing device and/or as an offset printing device and/or as a flexographic printing device and/or as a screen printing device and/or as an intaglio printing device and/or as a relief printing device and/or as a letterpress printing device and/or as a numbering device and/or as a varnishing device.

In an alternative or additional further development, the substrate categorising machine is preferably characterised in that at least one inspection device is designed as a first reflection inspection device and/or designed to detect signals reflected by a first side of a respective sheet and/or in that at least one inspection device is designed as a second reflection inspection device and/or designed to detect signals reflected by a second side of the respective sheet and/or in that at least one inspection device is designed as a transmission inspection device and/or designed to detect signals transmitted through a respective sheet and/or in that at least one inspection device is designed as a separation point inspection device and/or designed to detect signals emitted from at least one separation point of the respective sheet.

Exemplary embodiments of the invention are illustrated in the drawings and described in more detail below.

The drawings show:

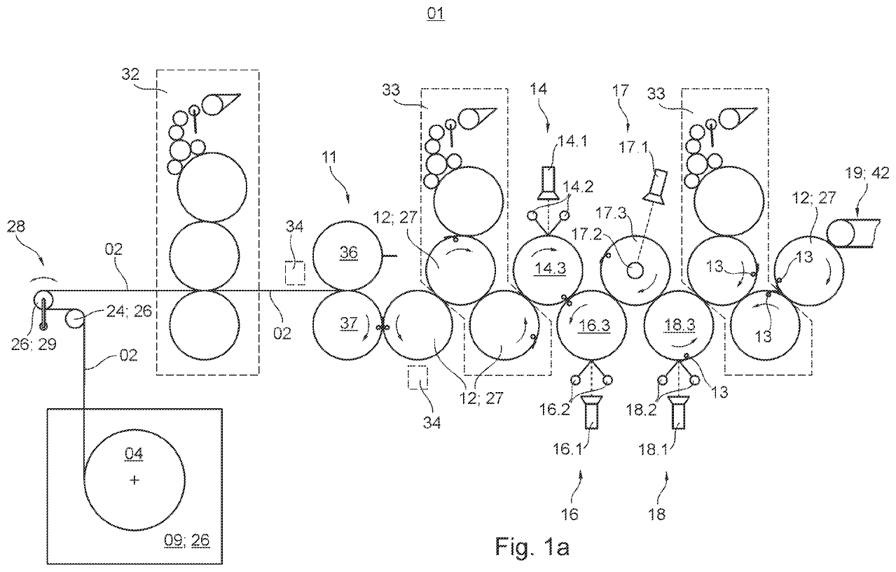

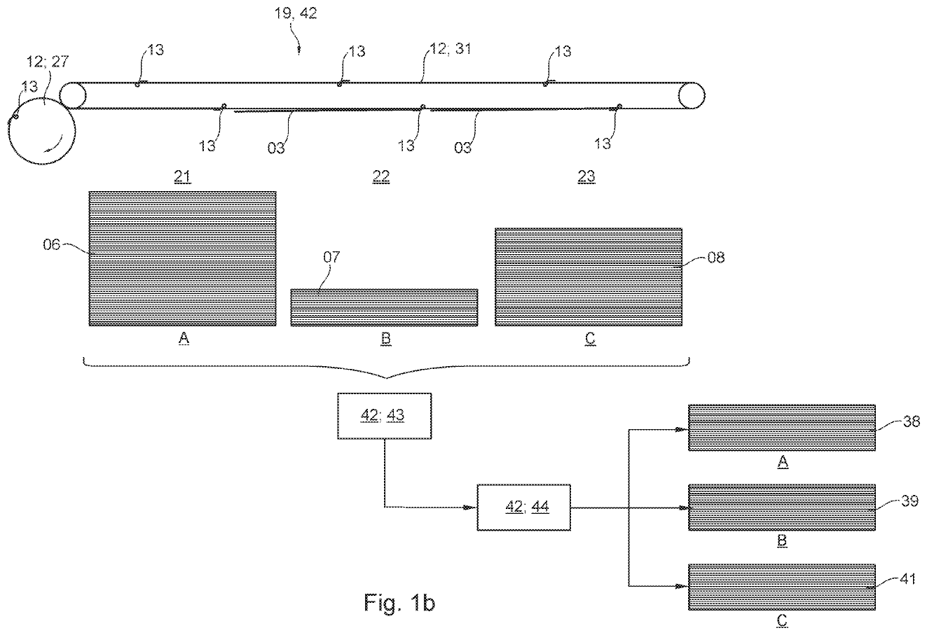

FIG. 1a a schematic depiction of a part of one of the substrate categorising machine or substrate processing machine, with components which can be omitted in alternative embodiments also being depicted;

FIG. 1b a schematic depiction of a further part of the substrate categorising machine or substrate processing machine according to FIG. 1a, as continuation thereof;

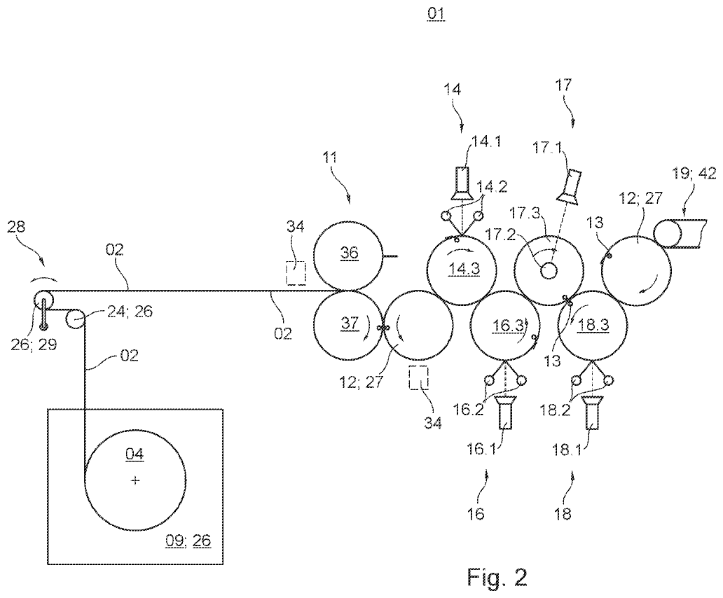

FIG. 2 a schematic depiction of a part of the substrate categorising machine alternative to that depicted in FIG. 1a;

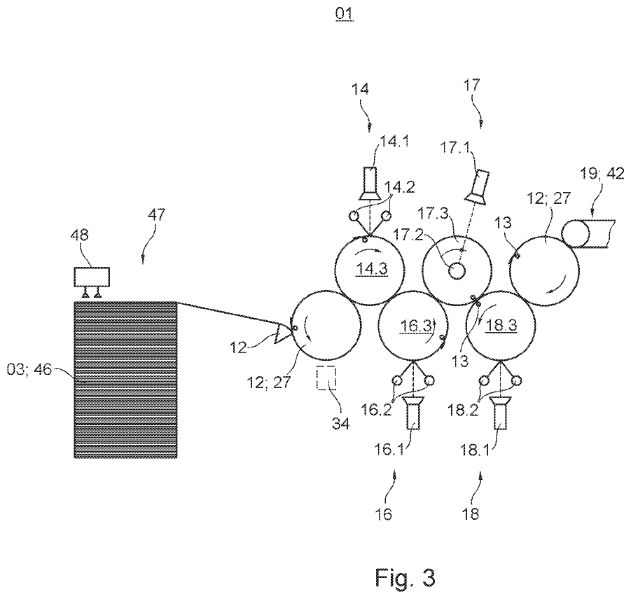

FIG. 3 a schematic depiction of a part of a substrate categorising machine which can be used alternatively to the parts depicted in FIG. 1a or FIG. 2.

If reference has been made, in the preceding and/or following text, to security papers or banknotes, this is to be understood in particular as banknotes, but also alternatively other security papers, for instance identification documents or the like. If reference has been made, in the preceding and/or following text, to substrate 02; 03 and/or a roll of material 04 and/or a material web 02 and/or sheets 03 and/or a feed pile 46, this is to be understood in particular as paper substrate 02; 03 and/or polymer substrate 02; 03 and/or hybrid substrate 02;03, in particular in the corresponding form as a roll 04 and/or web 02 and/or sheets 03 and/or feed pile 46.

The substrate 02; 03 is preferably a security paper substrate 02; 03, in particular paper substrate 02; 03 with a cotton content and/or polymer substrate 02; 03 and/or hybrid substrate 02; 03 with a cotton content and with a polymer content, wherein the polymer substrate 02; 03 and/or the polymer content further preferably has biaxially oriented polypropylene. The material web 02 is preferably a security paper web 02, in particular a paper web 02 with a cotton content and/or polymer web 02 and/or hybrid web 02 with a cotton content and with a polymer content, wherein the polymer web 02 and/or the polymer content preferably has biaxially oriented polypropylene. Sheets 03 are preferably security paper sheets 03, in particular paper sheets 03 with a cotton content and/or polymer sheets 03 and/or hybrid sheets 03 with a cotton content and with a polymer content, wherein the polymer sheets 03 and/or the polymer content preferably have/has biaxially oriented polypropylene.

Preference is given to a method for categorising at least one substrate 02; 03. The substrate 02; 03 is preferably separated into categories of sheets 03. In one embodiment, the substrate 02; 03 is supplied here as a material web 02, from which sheets 03 are severed and are then categorised. Alternatively, the substrate is removed from a feed pile 46 already as sheets 03 and categorised.

In an additional or alternative further development, the method is preferably characterised in that the method is a method for separating and categorising at least one substrate 02; 03, wherein substrate 02; 03 is transported in the form of a material web 02 along a provided transport path to a cross-cutting device 11 in a web supplying operation. For example, the substrate 02; 03 is first, or beforehand, unwound in particular in the form of the material web 02, in particular a respective corresponding portion of the material web 02, from a roll of material 04 in an unwinding operation. Alternatively, the material web 02 can be directly conveyed from a device which produces it to the cross-cutting device 11 without unrolling it beforehand. For example, the device producing the material web 02 is then a component of a substrate processing machine 01. The material web 02 is preferably separated into a plurality of sheets 03 by respective sheets 03 being severed from the material web 02 in a respective severing operation, in particular a cutting operation. The respective sheets 03 are preferably inspected in at least one respective inspection operation in each case with regard to at least one property that the substrate 02; 03 already had before the respective severing operation, wherein the sheets 03 are each assigned to one of at least three categories in a respective assigning operation on the basis of the result of the inspection carried out in the respective at least one inspection operation, and wherein each of the sheets 03 is deposited on a delivery pile 06; 07; 08 corresponding to its category in a respective delivery operation. In particular, accordingly, the respective sheets 03 are preferably inspected in the at least one respective inspection operation in each case with regard to at least one property that the substrate 02; 03 already had before any severing operation and which contributed to the creation of the respective sheet 03 from the material web 02.

Maintaining the order of the abovementioned operations, further operations can take place therebetween, for example processing operations. During their respective inspection operation, the respective sheets 03 are preferably arranged held by at least one gripper system 13.

In an additional or alternative further development, the method is preferably characterised in that the material web 02, i.e. in particular the part of the material web 02 not yet severed as sheets 03, is subjected to at least one processing operation at a processing point arranged along the transport path provided for the transport of substrate 02; 03 before a cross-cutting device 11 which carries out the respective severing operation. The respective corresponding processing operation is for example applying a security feature and/or embossing and/or applying a foil and/or printing and/or the offset printing operation and/or an intaglio printing operation and/or a screen printing operation and/or a hot stamping operation and/or a coating operation and/or a flexographic printing operation and/or a relief printing operation and/or a letterpress printing operation and/or a numbering operation and/or a varnishing operation and/or an inkjet printing operation and/or an operation for applying microlenses. In this way, for example, those processing operations which are essential and/or less cost-intensive and hence economically viable even when substrate has to be discarded and/or which are better to carry out on a material web 02 than on a sheet 03, are carried out at suitable locations and in suitable ways.

In an additional or alternative further development, the method is preferably characterised in that the respective sheets 03 are subjected to at least one processing operation after the respective severing operation and before the respective at least one inspection operation. The respective corresponding processing operation is for example applying a security feature and/or embossing and/or applying a foil and/or printing and/or the offset printing operation and/or an intaglio printing operation and/or a screen printing operation and/or a hot stamping operation and/or a coating operation and/or a flexographic printing operation and/or a relief printing operation and/or a letterpress printing operation and/or a numbering operation and/or a varnishing operation and/or an inkjet printing operation and/or an operation for applying microlenses. In this way, for example, those processing operations which are essential and/or less cost-intensive and hence economically viable even when substrate has to be discarded and/or which are better to carry out on a sheet 03 than on a material web 02, are carried out at suitable locations and in suitable ways. It should be noted in particular that the sheets 03 are then held in the gripper's grasp during this corresponding processing operation and can thus be positioned particularly precisely.

In an additional or alternative further development, the method is preferably characterised in that substrate 03 is removed in the form of a respective sheet 03 from a feed pile 46 and is isolated in a respective isolation operation, wherein the respective sheet 03 is transported in particular by means of at least one gripper system 13 along a provided transport path to at least one inspection device 14 in a respective sheet supplying operation, and wherein the respective sheets 03 are inspected in at least one respective inspection operation in each case with regard to at least one property that this respective sheet 03 already had before the respective isolation operation. The sheets 03 are preferably each assigned to one of at least three categories in a respective assigning operation on the basis of the result of the inspection carried out in the respective at least one inspection operation, wherein each of the sheets 03 is deposited on a delivery pile 06; 07; 08 corresponding to its category in a respective delivery operation. In an additional or alternative further development, the method is preferably characterised in that the sheets 03 are exclusively transported along the transport path from the feed pile 46 to the at least one inspection device 14 and in particular no material is applied to the sheets 03 or removed from the sheets 03 and the sheets 03 and/or the substrate 03 thereof are in particular not irreversibly changed.

In an additional or alternative further development, the method is preferably characterised in that, in the respective at least one inspection operation, the respective sheet 02; 03 is subjected to a one-sided reflection inspection and/or is subjected to a two-sided reflection inspection and/or is subjected to a transmission inspection and/or is subjected to a separation point inspection. A separation point inspection is in particular understood to mean that an inspection is carried out at a location at which a separation took place in the severing operation and/or at which a join existed before the severing operation and/or at which a new surface was formed by the severing operation, in particular regardless of whether this inspection is carried out as a reflection inspection and/or as a transmission inspection. Here, a quality of at least one separation point is investigated in particular. Additionally or alternatively, a length measurement is carried out, for example by calculating a length of the respective sheet from the relative position of the separation points.

In an additional or alternative further development, the method is preferably characterised in that the results of the at least one inspection operation are used to determine to which category the respective sheet 03 is assigned.

In an additional or alternative further development, the method is preferably characterised in that at least the respective sheets 03 which were assigned to a first of the at least three categories are subjected to at least one processing operation after the respective assigning operation and in that the processing operation is applying a security feature and/or embossing and/or applying a foil and/or printing and/or the offset printing operation and/or an intaglio printing operation and/or a screen printing operation and/or a hot stamping operation and/or a coating operation and/or a flexographic printing operation and/or a relief printing operation and/or a letterpress printing operation and/or a numbering operation and/or a varnishing operation and/or an inkjet printing operation and/or an operation for applying microlenses. Sheets of other categories are preferably eliminated. If therefore this processing takes place within the substrate categorising machine 01 and/or substrate processing machine 01, it can thereby be ensured that only those sheets 03 are used which are assigned to a corresponding category, in particular in order to save on costs.

In an additional or alternative further development, the method is preferably characterised in that in particular a first category of the at least three categories is an approved sheet category, to which those sheets 03 which completely meet the stipulated quality requirements are assigned. Said sheets are for example characterised in that they can be provided with impositions while utilising as much of their surface as possible, all of these impositions not being rejects, at least with regard to the substrate 02; 03, and accordingly being able to be used.

In an additional or alternative further development, the method is preferably characterised in that in particular a second category of the at least three categories is a reject category, to which those sheets 03 which are completely unusable, at least for the production of security papers, in particular banknotes, are assigned. This means, for example, that none of those sheets 03 can be used to produce usable impositions, in particular regardless of subsequent processing operations and/or at least not with a reasonable amount of effort. Sheets 03 which would only produce a small number of usable impositions can for example also be assigned to this reject category, depending on the requirements of a consumer of the sheets and/or impositions.

In an additional or alternative further development, the method is preferably characterised in that in particular a third category of the at least three categories is a mixed category, to which those sheets 03 which do not completely meet the stipulated quality requirements, but only have small flaws and are at least partially usable for the production of security papers, for example banknotes, are assigned. For example, individual regions of such sheets 03 can be processed to give usable impositions, but they ultimately have to be separated from other regions and/or impositions from which no usable impositions can be produced before and/or after further processing operations. This is for example the case if defective locations are restricted to just a limited and/or small region of the corresponding sheet 03.

In an additional or alternative further development, the method is preferably characterised in that, in the delivery operation and/or thereafter, the sheets 03 of the first category are supplied according to their respective category to a delivery pile 06 of a quality level A and/or to a further processing pile 38 of the quality level A and/or to a ream 38 of the quality level A, wherein those sheets 03 of a delivery pile 06 of the quality level A or of a pile 38 of the quality level A or of a ream 38 of the quality level A are provided for production of security papers, in particular banknotes. A further processing pile 38 here is preferably a different pile to the corresponding delivery pile 06 and for example has a predefined number of sheets 03, in particular different to the delivery pile 06, and/or is arranged on a different support than the delivery pile 06.

In an additional or alternative further development, the method is preferably characterised in that, in the delivery operation and/or thereafter, the sheets 03 of the second category are supplied according to their respective category to a delivery pile 06 of a quality level B and/or to a further processing pile 39 of the quality level B and/or to a ream 39 of the quality level B, wherein those sheets 03 of a delivery pile 07 of the quality level B or of a further processing pile 39 of the quality level B or of a ream 39 of the quality level B are provided for production of security papers, in particular banknotes in individual processing or for printing preparations or set-up operations of a processing machine. A further processing pile 39 here is preferably a different pile to the corresponding delivery pile 07 and for example has a predefined number of sheets 03, in particular different to the delivery pile 07, and/or is arranged on a different support than the delivery pile 07.

In an additional or alternative further development, the method is preferably characterised in that, in the delivery operation, the sheets 03 of the third category are supplied according to their respective category to a delivery pile 06 of a quality level C and/or to a further processing pile 41 of the quality level C and/or to a ream 41 of the quality level C and/or to a collecting device and/or a waste device, wherein those sheets 03 of a delivery pile 06 of the quality level C or of a further processing pile 41 of the quality level C or of a ream 41 of the quality level C are provided for example for printing preparations or set-up operations of a processing machine. A further processing pile 41 here is preferably a different pile to the corresponding delivery pile 08 and for example has a predefined number of sheets 03, in particular different to the delivery pile 08, and/or is arranged on a different support than the delivery pile 08.

For example, sheets 03 are collected in each case on the respective delivery pile 06; 07; 08 and removed therefrom and packaged and/or transported onward in the form of a respective further processing pile 38; 39; 41 or dispatch pile 38; 39; 41 and/or ream 38; 39; 41. A ream here is a measure of the number of sheets packaged in particular together. A ream preferably has 500 sheets 03. A further processing pile 38; 39; 41 of the dispatch pile 38; 39; 41 preferably has an amount of sheets 03 which meets the requirements, for example 5000 or 10,000, such that the dispatch pile can be immediately processed in a printing works. Particularly the sheets 03 of the quality level A can also be further processed immediately after the inspection operation and/or after the respective delivery operation by the substrate categorising machine 01 and/or substrate processing machine 01.

In an additional or alternative further development, the method is preferably characterised in that all method operations are carried out in the same substrate categorising machine 01 and/or substrate processing machine 01.

In an additional or alternative further development, the method is preferably characterised in that the respective sheets 03 are inspected in the respective at least one inspection operation in each case with regard to at least one property that the respective sheets 03 only obtained after the respective severing operation. This is particularly pertinent when the sheets are subjected to processing after the severing and the result of this processing is to be taken into account. Thus, for example, semi-finished sheets 03 can be produced and inspected, which sheets for example already have all the security features to be assigned to the substrate 02; 03 and additionally already have a security feature printed on and/or applied as a foil, but which have not yet been subjected to a complex further processing operation to which only actually usable sheets 03 should be subjected.

For example, the sheets 03 are checked in the at least one inspection operation for at least one or more or all of the following security features: Cut, in particular the parallelism of cuts and/or portion lengths; substrate faults such as inclusions of foreign bodies and/or holes; watermarks, in particular the position and/or completeness thereof; security threads, in particular the position and/or completeness and/or width and/or possible rotations thereof; reflective window threads, for example with holographic properties, in particular the position and/or completeness and/or rotation and/or width thereof and/or a number and/or length and/or width of apertures in the window thread; applied foils, in particular the position and/or completeness thereof; printed images, in particular the colouring and/or print registration accuracy and/or registration accuracy and/or completeness thereof. Except for the cut and/or printed images, the respective security feature is for example the at least one property that the substrate 02; 03 already had before the respective severing operation or isolation operation.

In an additional or alternative further development, the method is preferably characterised in that, for example after the cutting and in particular before any further processing, at least one sheet 03 and/or each of at least two sheets 03 and/or each sheet 03 has a plurality of similar and/or identical security features which are arranged on each respective sheet 03 in a respective matrix made of a plurality of rows and a plurality of columns. Similar security features here are for example alike in their nature but not identical. Thus, security threads of banknotes can be arranged in each banknote with a different section but at the same location. Watermarks or holograms, on the other hand, are preferably examples of security features which are identical for all impositions.

In an additional or alternative further development, the method is preferably characterised in that a width of at least one sheet 03 and/or of each of at least two sheets 03 and/or of each sheet 03 is greater than a multiple of a width of an imposition and/or security paper arranged and/or to be arranged on the sheet 03. The width is for example a dimension measured transversely to the transport direction oriented along the transport path provided for the transport of the substrate 02; 03. In an additional or alternative further development, the method is preferably characterised in that a length of at least one sheet 03 and/or of each of at least two sheets 03 and/or of each sheet is greater than a multiple of a length of an imposition and/or security paper arranged and/or to be arranged on the sheet 03. The length is for example a dimension measured in the transport direction oriented along the transport path provided for the transport of the substrate 02; 03.

Each sheet 03 is preferably provided with an individual mark, for example by means of at least one marking device 34. The respective individual mark is for example designed as a barcode, for example as a one-dimensional barcode or as a two-dimensional barcode or as a three-dimensional barcode. By means of such an individual mark, each sheet 03 is in particular identifiable at anytime and can for example be processed in a manner befitting its category. The respective individual mark is preferably applied in a region of the sheet 03 which is later severed and/or is no longer physically joined to any of the impositions after the security papers, in particular banknotes, have been produced.

There are various types of barcodes. Barcodes always form, for example, a planar arrangement of markings. A distinction can be made between one-dimensional barcodes, two-dimensional barcodes and three-dimensional barcodes. One-dimensional barcodes have a successive sequence of bars of different widths, which are usually each coloured in one of two colours, in particular either black or white. These bars are arranged one after the other along a linear direction or main orientation. Two-dimensional barcodes, in particular matrix codes, have markings which are arranged in a plurality of rows and in a plurality of columns. The rows and columns are preferably orthogonal to one another, but other angles are also possible, as for example in what is referred to as the MaxiCode. The markings thus form a matrix. The markings are usually each coloured in one of two colours, in particular either black or white. A three-dimensional barcode is understood in particular to mean a barcode which is substantially constructed like a two-dimensional barcode, but the markings of which have more than two colours overall, with the different colours conveying a further level of meaning. A two-dimensional or three-dimensional barcode, in particular a matrix code, requires less space than a one-dimensional barcode for the same amount of information.

The preferred substrate categorising machine 01, which is further preferably designed as a substrate processing machine 01, is described hereinafter. The substrate categorising machine 01 and/or substrate processing machine 01 is preferably designed to carry out the preferred method for categorising or for separating and categorising the at least one substrate 02; 03.

In one embodiment, the substrate categorising machine 01 and/or substrate processing machine 01 preferably has at least one material web source 09 and/or at least one web transport system 26. In an alternative or additional further development, the substrate processing machine 01 is preferably characterised in that the substrate categorising machine 01 and/or substrate processing machine 01 has at least one web transport system 26 with at least one deflecting means 24, for example with at least one deflecting roller 24 and/or at least one deflecting roll 24 and/or with at least one deflecting rod 24. The web transport system 26 preferably has at least one web tension regulator 28 which for example has at least one displaceable, in particular pivotable, dancer roller 29. When rolls of material 04 are used, the at least one material web source 09 is for example designed as a roll unwinding device 09. The material web 02 is preferably unwound from the roll of material 04 by means of the roll unwinding device 09. In an alternative embodiment, the material web source 09 is designed as a substrate producing device 09, for example as a papermaking device 09 and/or polymer producing device 09 and/or hybrid substrate producing device 09. Direct or indirect connection of the substrate categorising machine 01 and/or substrate processing machine 01 to another and/or an external material web source is also possible. In conjunction with this embodiment of the substrate categorising machine 01 and/or substrate processing machine 01, in any case the substrate is preferably first present in the form of a material web 02 and is present as such in the substrate categorising machine 01 and/or substrate processing machine 01 before it is separated into sheets 03.

The substrate categorising machine 01 and/or substrate processing machine 01 preferably has in particular a roll unwinding device 09 along a transport path provided for the transport of at least one substrate 02; 03 after the material web source 09 and/or preferably at least one cross-cutting device 11 after the web transport system 26, which cross-cutting device is further preferably designed as a cross-cutting guillotine device 11. The material web 02 can thereby be separated into individual sheets 03, which are ultimately used for the production of the impositions, in particular security papers and/or banknotes. The at least one cross-cutting device 11 is preferably designed as a cross-cutting guillotine device 11. For example, the at least one cross-cutting device 11 has at least one cutting cylinder 36 and at least one counter-pressure cylinder 37. The at least one cutting cylinder 36 in this case preferably carries at least one blade. The material web 02 is then preferably conveyed through a separation gap formed by the at least one cutting cylinder 36 on one side and the at least one counter-pressure cylinder 37 on the other side and cut into sheets 03 there.

The substrate categorising machine 01 and/or substrate processing machine 01 has at least one sheet transport device 12 along the transport path provided for the transport of the substrate 02; 03 after the at least one cross-cutting device 11, which sheet transport device further preferably has at least one gripper system 13.

The material web source 09 and the web transport system 26 and the at least one cross-cutting device 11 can be considered together as the sheet source. In an alternative or additional further development, the substrate categorising machine 01 and/or substrate processing machine 01 is preferably characterised in that at least one sheet source 47 designed as a sheet feeder 47 is arranged, which for example has at least one separating device 48 for isolating sheets 03 from a feed pile 46, and/or has at least one oscillating gripper system 12.

Other belt transport systems can also be used, but the use of at least one gripper system 13 is considered to be advantageous due to the precise fixing of the relative position of the sheets 03. In an alternative or additional further development, the substrate categorising machine 01 and/or substrate processing machine 01 is preferably characterised in that the substrate categorising machine 01 and/or substrate processing machine 01 has at least one sheet transport system 27 with at least one sheet transport device 12 and/or at least one gripper system 13. The at least one sheet transport device 12 is for example designed as at least one transport reel 12 and/or at least one transport roller 12 and/or at least one transport cylinder 12 and/or at least one chain gripper system 12; 31. The substrate categorising machine 01 and/or substrate processing machine 01 has at least one inspection device 14; 16; 17; 18 and preferably a plurality of inspection devices 14; 16; 17; 18 along the transport path provided for the transport of the substrate 02; 03 after the sheet source 47 and/or after the at least one cross-cutting device 11 and in particular along a portion of the transport path provided for the transport of sheets 03. A plurality of inspection devices 14; 16; 17; 18 can also be combined into a functional group or for example combined with one another on the basis of their analytical technology, but are nonetheless to be regarded as a plurality of inspection devices 14; 16; 17; 18, in particular if independent sensors are arranged in each case. This inspection device serves in particular to enable the sheets 03 to be sorted based on quality into one of the at least three categories, and as a result to reduce costs of unnecessary substrate processing and/or unnecessary substrate consumption.

The substrate categorising machine 01 and/or substrate processing machine 01 has at least one delivery device 19 along the transport path provided for the transport of the substrate 02; 03 after the at least one inspection device 14; 16; 17; 18, which delivery device has at least three depositing stations 21; 22; 23 arranged in particular one behind the other along the transport path provided for the transport of substrate 02; 03. The at least one delivery device 19 is therefore preferably designed as a multi-pile delivery 19, in particular at least as a three-pile delivery 19. The depositing stations 21; 22; 23 are also referred to as pile deliveries 21; 22; 23. A respective depositing station 21; 22; 23 or pile delivery 21; 22; 23 is to be understood here in particular to mean a device which serves to form a respective pile. By means of the at least three depositing stations 21; 22; 23, therefore, at least three different delivery piles 06; 07; 08 can be formed, without in each case having to remove another pile. As a result, the sheets 03 can be assigned to at least three different categories.

In an alternative or additional further development, the substrate processing machine 01 is preferably characterised in that the at least one inspection device 14; 16; 17; 18 is arranged along the portion of the transport path provided for the transport of sheets 03 and/or in that the at least one inspection device 14; 16; 17; 18 is provided for inspection of the sheets 03. In an alternative or additional further development, the substrate processing machine 01 is preferably characterised in that a plurality of inspection devices 14; 16; 17; 18 are arranged as the at least one inspection device 14; 16; 17; 18.

In an alternative or additional further development, the substrate processing machine 01 is preferably characterised in that at least one inspection device 14 is designed as a first reflection inspection device 14 and/or is designed to detect signals reflected by a first side of a respective sheet 03. This at least one, in particular first, reflection inspection device 14 preferably has at least one in particular optical sensor 14.1, in particular at least one camera 14.1, which is further preferably designed as a line scan camera 14.1. The at least one, in particular first, reflection inspection device 14 preferably has at least one illumination device 14.2. The at least one, in particular first, reflection inspection device 14 preferably interacts with at least one sheet transport device 14.3, for example with at least one sheet transport reel 14.3 or at least one sheet transport roller 14.3 or at least one sheet transport cylinder 14.3. This ensures an optimal position of the respective sheet 03 during the inspection, in particular if the respective sheet 03 is held in this position by means of at least one gripper system 13.

In an alternative or additional further development, the substrate processing machine 01 is preferably characterised in that at least one inspection device 16 is designed as a second reflection inspection device 16 and/or is designed to detect signals reflected by a second side of the respective sheet 03, in particular the side lying opposite the first side of the respective sheet 03. This at least one, in particular second, reflection inspection device 16 preferably has at least one in particular optical sensor 16.1, in particular at least one camera 16.1, which is further preferably designed as a line scan camera 16.1. The at least one, in particular second, reflection inspection device 16 preferably has at least one illumination device 16.2. The at least one, in particular second, reflection inspection device 16 preferably interacts with at least one sheet transport device 16.3, for example with at least one sheet transport reel 16.3 or at least one sheet transport roller 16.3 or at least one sheet transport cylinder 16.3. This ensures an optimal position of the respective sheet 03 during the inspection, in particular if the respective sheet 03 is held in this position by means of at least one gripper system 13.

In an alternative or additional further development, the substrate processing machine 01 is preferably characterised in that at least one inspection device 17 is designed as a transmission inspection device 17 and/or is designed to detect signals transmitted through a respective sheet 03. This at least one transmission inspection device 17 preferably has at least one in particular optical sensor 17.1, in particular at least one camera 17.1, which is further preferably designed as a line scan camera 17.1. The at least one transmission inspection device 17 preferably has at least one illumination device 17.2. The at least one transmission inspection device 17 preferably interacts with at least one sheet transport device 17.3, for example with at least one sheet transport reel 17.3 or at least one sheet transport roller 17.3 or at least one sheet transport cylinder 17.3. This ensures an optimal position of the respective sheet 03 during the inspection, in particular if the respective sheet 03 is held in this position by means of at least one gripper system 13. For example, the at least one illumination device 17.2 of the transmission inspection device 17 is arranged within the sheet transport device 17.3 of the transmission inspection device 17.

In an alternative or additional further development, the substrate processing machine 01 is preferably characterised in that at least one inspection device 18 is designed as a separation point inspection device 18 and/or is designed to detect signals emitted, in particular reflected and/or transmitted, by at least one separation point of the respective sheet 03. For example, the at least one separation point inspection device 18 is also designed as an in particular third reflection inspection device 18. Alternatively or additionally, the first or the second reflection inspection device 14; 16 can also be used as a separation point inspection device 18. This at least one separation point inspection device 18 preferably has at least one in particular optical sensor 18.1, in particular at least one camera 18.1, which is further preferably designed as a line scan camera 18.1. The at least one separation point inspection device 18 preferably has at least one illumination device 18.2. The at least one separation point inspection device 18 preferably interacts with at least one sheet transport device 18.3, for example with at least one sheet transport reel 18.3 or at least one sheet transport roller 18.3 or at least one sheet transport cylinder 18.3. This ensures an optimal position of the respective sheet 03 during the inspection, in particular if the respective sheet 03 is held in this position by means of at least one gripper system 13. For example, the separation point inspection device 18 and/or one of the other inspection devices 14; 16; 17 is designed and/or operated and/or designed to be suitable as a length inspection device 14; 16; 17; 18.

In an alternative or additional further development, the substrate processing machine 01 is preferably characterised in that the substrate categorising machine 01 and/or substrate processing machine 01 has at least one web processing device 32 for processing the material web 02 in particular before the severing and/or cutting up of the sheets 03. For example, a plurality of web processing devices 32 are arranged one behind the other along the transport path provided for the transport of the substrate 02; 03. This at least one web processing device 32 is preferably arranged along the transport path provided for the transport of substrate 02; 03 after the at least one roll unwinding device 09 and before the cross-cutting device 11. This at least one web processing device 32 is for example designed as a foil application device 32 and/or as a hot stamping device 32 and/or as an embossing device 32 and/or as a coating device 32 and/or as a printing device 32, in particular offset printing device 32 and/or flexographic printing device 32 and/or screen printing device 32 and/or intaglio printing device 32 and/or relief printing device 32 and/or letterpress printing device 32 and/or as a numbering device 32 and/or as a varnishing device 32. This at least one web processing device 32 is for example designed to process the material web 02 on one side or two sides.

In an alternative or additional further development, the substrate processing machine 01 is preferably characterised in that the substrate categorising machine 01 and/or substrate processing machine 01 has at least one sheet processing device 33 for processing the sheets 03 in particular after the severing and/or cutting up thereof from the material web 02. For example, a plurality of sheet processing devices 33 are arranged one after the other along the transport path provided for the transport of the substrate 02; 03.

For example, at least one of these sheet processing devices 33 is arranged along the transport path provided for the transport of substrate 02; 03 after the at least one cross-cutting device 11 and before the at least one inspection device 14; 16; 17; 18. In an alternative or additional further development, at least one of these sheet processing devices 33 is preferably arranged along the transport path provided for the transport of substrate 02; 03 after the at least one inspection device 14; 16; 17; 18 and before the at least one delivery device 19. This ensures in particular an optimal position of the respective sheet 03 during the respective processing by means of the at least one preferably arranged sheet processing device 33, in particular if the respective sheet 03 is held in this position by means of at least one gripper system 13. The substrate processing device 01 preferably has at least one gripper system 13 in the region of the at least one preferably arranged sheet processing device 33.

This at least one sheet processing device 33 is for example designed as a foil application device 33 and/or as a hot stamping device 33 and/or as an embossing device 33 and/or as a coating device 33 and/or as a printing device 33, in particular offset printing device 33 and/or flexographic printing device 33 and/or screen printing device 33 and/or intaglio printing device 33 and/or relief printing device 33 and/or letterpress printing device 33 and/or as a numbering device 33 and/or as a varnishing device 33. This at least one sheet processing device 33 is for example designed to process the sheets 03 on one side or two sides. For example, the opaque layers can be applied to polymer substrate 02; 03 by means of the intaglio printing process. For example, optically variable surfaces can be generated on the substrate 02; 03 by means of the screen printing process.

In an alternative or additional further development, the substrate processing machine 01 is preferably characterised in that only sheet transport devices 12; 14.3; 16.3; 17.3; 18.3 are arranged to act on and/or be capable of acting on the sheet-like substrate 02; 03, and/or in particular no devices for applying material to the sheet-like substrate 02; 03 and/or for removing material from the sheet-like substrate 02; 03 and/or for irreversibly changing the sheet-like substrate 02; 03 are arranged to act on and/or be capable of acting on the sheet-like substrate 02; 03, along the transport path provided for the transport of the sheet-like substrate 02; 03 between the sheet source 47 and the at least one inspection device 14; 16; 17; 18.

In an alternative or additional further development, the substrate processing machine 01 is preferably characterised in that the substrate categorising machine 01 and/or substrate processing machine 01 has at least one marking device 34 for individually marking the material web 02 and/or preferably the respective sheets 03. The at least one marking device 34 is for example designed as a non-impact printer 34, in particular as an inkjet printer 34. The at least one marking device 34 is for example arranged along the transport path provided for the transport of the material web 02, i.e. before the at least one cross-cutting device 11. In an alternative or additional further development, the at least one marking device 34 is preferably arranged along the transport path provided for the transport of sheets 03, in particular after the at least one cross-cutting device 11 and/or after the at least one sheet source 47. For example, the marks on the respective sheets 03 can already themselves contain information regarding which category the sheet 03 has been assigned to. To this end, in particular, the at least one marking device 34 is preferably arranged along the transport path provided for the transport of the sheets 03 after the at least one inspection device 14; 1617; 18. Such information can however alternatively or additionally be stored in a database and linked to the respective mark and/or be delivered together with the respective sheet 03 and/or pile and/or ream.

In an alternative or additional further development, the substrate processing machine 01 is preferably characterised in that the substrate categorising machine 01 and/or substrate processing machine 01 has at least one sheet logistics device 42, which serves for the creation of further processing piles 38; 39; 41 and/or dispatch piles 38; 39; 41 and/or reams 38; 39; 41 and/or the discharge of sheets 03 sorted in some other way. For example, the sheet logistics device 42 has the delivery device 19 and/or at least one pile device 43 for generating counted further processing piles 38; 39; 41 and/or dispatch piles 38; 39; 41 and/or reams 38; 39; 41 and/or at least one packaging device 44. The packaging device 44 can for example be dispensed with if the further processing pile 38; 39; 41 is further processed in situ.

### LIST OF REFERENCE SIGNS

01 Substrate categorising machine, substrate processing machine
02 Substrate, web, material web, security paper substrate, paper substrate, polymer substrate, hybrid substrate, security paper web, paper web, polymer web, hybrid web
03 Substrate, sheet, security paper substrate, paper substrate, polymer substrate, hybrid substrate, security paper sheet, paper sheet, polymer sheet, hybrid sheet
04 Roll of material, roll
05 -
06 Delivery pile
07 Delivery pile
08 Delivery pile
09 Material web source, roll unwinding device, substrate producing device, papermaking device, polymer producing device, hybrid substrate producing device
10 -
11 Cross-cutting device, cross-cutting guillotine device
12 Sheet transport device, transport reel, transport roller, transport cylinder, chain gripper system, oscillating gripper system
13 Gripper system
14 Inspection device, reflection inspection device, first
14.1 Sensor, camera, line scan camera
14.2 Illumination device
14.3 Sheet transport device, sheet transport reel, sheet transport roller, sheet transport cylinder
15 -
16 Inspection device, reflection inspection device, second
16.1 Sensor, camera, line scan camera
16.2 Illumination device
16.3 Sheet transport device, sheet transport reel, sheet transport roller, sheet transport cylinder
17 Inspection device, transmission inspection device
17.1 Sensor, camera, line scan camera
17.2 Illumination device
17.3 Sheet transport device, sheet transport reel, sheet transport roller, sheet transport cylinder
18 Inspection device, separation point inspection device, reflection inspection device, third
18.1 Sensor, camera, line scan camera
18.2 Illumination device
18.3 Sheet transport device, sheet transport reel, sheet transport roller, sheet transport cylinder
19 Delivery device, multi-pile delivery, three-pile delivery
20 -
21 Depositing station
22 Depositing station
23 Depositing station
24 Deflecting means, deflecting roller, deflecting roll, deflecting rod
25 -
26 Web transport system
27 Sheet transport system
28 Web tension regulator
29 Dancer roller
30 -
31 Chain gripper system
32 Web processing device, foil application device, hot stamping device, embossing device, coating device, printing device, offset printing device, flexographic printing device, screen printing device, intaglio printing device, relief printing device, letterpress printing device, numbering device, varnishing device
33 Sheet processing device, foil application device, hot stamping device, embossing device, coating device, printing device, offset printing device, flexographic printing device, screen printing device, intaglio printing device, relief printing device, letterpress printing device, numbering device, varnishing device
34 Marking device, non-impact printer, inkjet printer
35 -
36 Cutting cylinder
37 Counter-pressure cylinder
38 Further processing pile, dispatch pile, ream
39 Further processing pile, dispatch pile, ream
40 -
41 Further processing pile, dispatch pile, ream
42 Sheet logistics device
43 Piling device
44 Packaging device
45 -
46 Feed pile
47 Sheet source, sheet feeder
48 Separating device

1. Method for separating and categorising at least one substrate by means of a substrate categorising machine, wherein substrate is transported in the form of a material web along a provided transport path to a cross-cutting device of the substrate categorising machine in a web supplying operation and wherein the material web is separated into a plurality of sheets by respective sheets being severed from the material web in a respective severing operation and wherein the respective sheets are inspected, by means of at least one inspection device of the substrate categorising machine, which inspection device is arranged along a transport path provided for the transport of the substrate after the cross-cutting device, in at least one respective inspection operation in each case with regard to at least one property that the substrate already had before the respective severing operation, and wherein the sheets are each assigned to one of at least three categories in a respective assigning operation on the basis of the result of the inspection carried out in the respective at least one inspection operation, and wherein each of the sheets is deposited on a delivery pile corresponding to its category in a respective delivery operation.

2. Method for categorising at least one substrate, wherein substrate is removed in the form of a respective sheet from a feed pile and is isolated in a respective isolation operation, and wherein the respective sheet is transported along a provided transport path to at least one inspection device in a respective sheet supplying operation, and wherein the respective sheets are inspected in at least one respective inspection operation in each case with regard to at least one property that this respective sheet already had before the respective isolation operation, and wherein the sheets are each assigned to one of at least three categories in a respective assigning operation on the basis of the result of the inspection carried out in the respective at least one inspection operation, and wherein each of the sheets is deposited on a delivery pile corresponding to its category in a respective delivery operation.

3. Method according to claim 1, wherein the material web is subjected to at least one processing operation at a processing point arranged along the transport path provided for the transport of substrate before a cross-cutting device which carries out the respective severing operation, and in that the respective processing operation is applying a security feature and/or embossing and/or applying a foil and/or printing and/or the offset printing operation and/or an intaglio printing operation and/or a screen printing operation and/or a hot stamping operation and/or a coating operation and/or a flexographic printing operation and/or a relief printing operation and/or a letterpress printing operation and/or a numbering operation and/or a varnishing operation and/or an inkjet printing operation and/or an operation for applying microlenses.

4. Method according to claim 1, wherein the respective sheets are subjected to at least one processing operation after the respective severing operation and before the respective at least one inspection operation and in that the processing operation is applying a security feature and/or embossing and/or applying a foil and/or printing and/or the offset printing operation and/or an intaglio printing operation and/or a screen printing operation and/or a hot stamping operation and/or a coating operation and/or a flexographic printing operation and/or a relief printing operation and/or a letterpress printing operation and/or a numbering operation and/or a varnishing operation and/or an inkjet printing operation and/or an operation for applying microlenses.

5. Method according to claim 2, wherein the sheets are exclusively transported along the transport path from the feed pile to the at least one inspection device and in the process no material is applied to the sheets or removed from the sheets and/or the sheets and/or the substrate thereof are not irreversibly changed in the process.

6. Method according to claim 1, wherein said at least one property is formed as a substrate fault and/or at least one inclusion of at least one foreign body and/or at least one hole and/or as a watermark and/or as the position and/or completeness of a watermark and/or as a security thread and/or the position and/or completeness and/or width and/or possible rotation of a security thread and/or as a reflective window thread and/or as a reflective window thread with holographic properties and/or as the position and/or completeness and/or rotation and/or width of a window thread and/or as the number and/or length and/or width of apertures in a window thread and/or as an applied foil and/or as the position and/or completeness of at least one applied foil.

7. (canceled)

8. (canceled)

9. Method according to claim 1, wherein, in the respective at least one inspection operation, the respective sheet (02; 03) is subjected to a one-sided reflection inspection and/or is subjected to a two-sided reflection inspection and/or is subjected to a transmission inspection and/or is subjected to a separation point inspection.

10-13. (canceled)

14. Method according to claim 1, wherein each sheet is provided with an individual mark and/or in that each sheet is provided with an individual mark by means of at least one marking device.

15. (canceled)

16. Substrate categorising machine for sorting sheets into different categories depending on their nature by means of a method for categorising at least one substrate, wherein sheets are each assigned to one of at least three categories in a respective assigning operation on the basis of a result of an inspection carried out by means of at least one inspection device in a respective inspection operation, and wherein each of the sheets is deposited on a delivery pile corresponding to its category in a respective delivery operation, wherein the respective sheets are inspected in at least one respective inspection operation in each case with regard to at least one property that the substrate already had before a respective severing operation, and wherein the substrate categorising machine is designed as a substrate processing machine and wherein the substrate categorising machine has at least one material web source and/or at least one web transport system and wherein the substrate categorising machine has at least one cross-cutting device along a transport path provided for the transport of at least one substrate after the material web source and/or after the web transport system and wherein the substrate categorising machine has at least one sheet transport device along the transport path provided for the transport of the substrate after the at least one cross-cutting device, which sheet transport device has at least one gripper system, and wherein the substrate categorising machine has the at least one inspection device along the transport path provided for the transport of the substrate after the at least one cross-cutting device and wherein the substrate categorising machine has at least one delivery device along the transport path provided for the transport of the substrate after the at least one inspection device, which delivery device has at least three depositing stations for forming the delivery pile.

17. Substrate categorising machine for sorting sheets into different categories depending on their nature by means of a method for categorising at least one substrate, wherein sheets are each assigned to one of at least three categories in a respective assigning operation on the basis of a result of an inspection carried out by means of at least one inspection device in a respective inspection operation, and wherein each of the sheets is deposited on a delivery pile corresponding to its category in a respective delivery operation, and wherein the respective sheets are inspected in at least one respective inspection operation in each case with regard to at least one property that this respective sheet already had before a respective isolation operation, and wherein the substrate categorising machine has at least one sheet source designed as a sheet feeder and wherein the substrate categorising machine has at least one sheet transport device along a transport path provided for the transport of sheet-like substrate after the sheet source, which sheet transport device has at least one gripper system, and wherein the substrate categorising machine has the at least one inspection device along the transport path provided for the transport of the sheet-like substrate after the sheet source and wherein the substrate categorising machine has at least one delivery device along the transport path provided for the transport of the sheet-like substrate after the at least one inspection device, which delivery device has at least three depositing stations for forming a delivery pile and wherein only sheet transport devices which act on and/or are capable of acting on the sheet-like substrate are arranged along the transport path provided for the transport of the sheet-like substrate between the sheet source and the at least one inspection device.

18. Substrate categorising machine according to claim 16, wherein the substrate categorising machine has at least one web processing device for processing the material web and/or in that the substrate categorising machine has at least one web processing device for processing the material web which is designed as a foil application device and/or as a hot stamping device and/or as an embossing device and/or as a coating device and/or as a printing device and/or as an offset printing device and/or as a flexographic printing device and/or as a screen printing device and/or as an intaglio printing device and/or as a relief printing device and/or as a letterpress printing device and/or as a numbering device.

19. Substrate categorising machine according to claim 16, wherein the substrate categorising machine has at least one sheet processing device for processing the sheets, which sheet processing device is arranged along the transport path provided for the transport of substrate after the at least one cross-cutting device and before the at least one inspection device.

20. Substrate categorising machine according to claim 16, wherein the substrate categorising machine has at least one sheet processing device for processing the sheets, which sheet processing device is arranged along the transport path provided for the transport of substrate after the at least one inspection device and before the at least one delivery device.

21. (canceled)

22. Substrate categorising machine according to claim 16, wherein at least one inspection device is designed as a first reflection inspection device and/or to detect signals reflected by a first side of a respective sheet and/or in that at least one inspection device is designed as a second reflection inspection device and/or to detect signals reflected by a second side of the respective sheet and/or in that at least one inspection device is designed as a transmission inspection device and/or to detect signals transmitted through a respective sheet and/or in that at least one inspection device is designed as a separation point inspection device and/or to detect signals emitted from at least one separation point of the respective sheet.

23-28. (canceled)

29. Substrate categorising machine according to claim 16, wherein the substrate categorising machine and/or substrate processing machine has at least one marking device for individually marking the material web and/or the respective sheets.
